(19) United States
(12) Patent Application Publication
(10) Pub. No.: US 2018/0171125 A1
(43) Pub. Date: Jun. 21, 2018

(54) POLYMER COMPOSITION COMPRISING LINEAR LOW-DENSITY POLYETHYLENE

(71) Applicant: SABIC Global Technologies B.V., Bergen op Zoom (NL)

(72) Inventors: Said Fellahi, Riyadh (SA); Yahya Banat, Geleen (NL); Maria Johanna Willems, Geleen (NL); Bart van den Esschert, Geleen (NL); Abdulaziz Hamad Al-Humydi, Geleen (NL)

(21) Appl. No.: 15/738,591

(22) PCT Filed: Jun. 23, 2016
(86) PCT No.: PCT/EP2016/064566

§ 371 Date: Dec. 21, 2017

(30) Foreign Application Priority Data
Jun. 25, 2015 (EP) 15173845.7

(51) Int. Cl. C08L 23/06; C08K 5/092; C08J 5/18; B65D 81/18

(52) U.S. Cl. CPC C08L 23/06; C08K 5/092; C08J 5/18; B65D 81/18; C08J 2323/08; C08L 2205/24; C08L 2207/066; C08L 2314/06; C08L 2203/16

(57) ABSTRACT

The present invention relates to a polymer composition comprising a linear low-density polyethylene produced in the presence of a single-site catalyst system and 0.01-2.00% by weight of a nucleating agent, the linear low-density polyethylene having a density as determined according to ISO 1183-1 (2012), method A of >900 kg/m³and ≤940 kg/m³, wherein films produced using the polymer composition have a total defected area of ≤50 ppm of surface, the total defected area being the fraction of surface area of the film accounted for by gels having an equivalent diameter of >50 μm. Such polymer compositions are suitable for the production of films having a low oxygen transmission rate and a low water vapour transmission rate.

The present invention relates to polymer compositions comprising linear low-density polyethylene and films comprising such polymer compositions having a reduced permeability to oxygen and water vapour. Furthermore, the present invention relates to packages comprising such films, in particular packages for packing fresh foodstuffs.

Polymer compositions comprising linear low-density polyethylene are well known for use in film applications. Films manufactured from linear low-density polyethylenes are commonly used for a wide variety of applications, such as for example in packaging. For example, such films may be used in flexible packaging. Linear low-density polyethylenes have many advantageous properties for films over other types of materials, such as for example optical properties and mechanical properties. Advantageous optical properties of linear low-density polyethylenes are for example haze, gloss and clarity. Advantageous mechanical properties of linear low-density polyethylene materials are for example tear resistance, impact strength, and toughness in frozen conditions. In particular, linear low-density polyethylenes provide such balance of these properties that render them particularly suitable for use in the preparation of films. Linear low-density polyethylenes may be processed into very thin films, such as for example films having a thickness of ≥1.0 and ≤50.0 μm.

A particular type of packaging in which films of linear low-density polyethylene are used is in food packaging, for example in packaging of fresh food or dry foodstuffs. In packaging of fresh food, a critical parameter is the permeability of the package to oxygen and water vapour, as the presence of oxygen and water vapour inside the package has a detrimental effect on the shelf life of fresh food. In packaging of dry foodstuffs, permeability of the package to oxygen and water vapour is also an important parameter as such foodstuffs need to be kept dry to avoid deterioration of quality. It is therefore desirable to apply a package comprising a film that provides a certain balance of low permeability properties whilst allowing for low film thickness. Reduction of thickness is desirable as it directly affects the total weight of the package, as well as the consumption of materials used to produce the package.

Films of linear low-density polyethylenes may further be used in for example stretch-wrap films, shrink films, food bags, retail bag, trash can liners, heavy-duty sacks, construction films and agricultural films.

A disadvantage of linear low-density polyethylenes according to the state of the art is that the permeability of films made using such linear low-density polyethylenes to oxygen and/or water vapour can be too high for certain applications.

Various solutions have been suggested to reduce the oxygen and/or water vapour permeability of linear low-density polyethylene films.

For example, WO2014/159822 A1 addresses the issue of oxygen transmission and water vapour transmission of linear low-density polyethylene films, and presents linear low-density polyethylenes having a defined comonomer distribution profile. However, films of these materials show only a limited improvement in reduction of oxygen transmission rate, whilst also providing poor values for haze and Elmendorf tear resistance.

Various publications suggest to reduce the permeability of linear low-density polyethylenes to oxygen and/or water vapour by applying multi-layer film systems in which the reduction of permeability is achieved by incorporation of a material that has a lower permeability to oxygen and/or water vapour than the linear low-density polyethylenes according to the state of the art. An example of such solution is presented in US2014/0134446A1. This solution does present a reduction of permeability, however such multi-layer systems require specialised equipment to produce as well as specialised equipment to be processed. Also, the additional materials used for for example the barrier layer may result in deterioration of other properties such as the toughness in frozen conditions. Another disadvantage is that such multi-layer film systems may comprise combinations of different types of polymers in the different layers, including in potential tie layers, which results in difficulties in recyclability of such film systems.

Alternatively, permeability may be reduced by increasing the thickness of the film. However, this is not desirable as it increases the consumption of materials required to produce such package.

For that reason, there is an ongoing need to develop linear low-density polyethylene materials for films having reduced permeability to oxygen and water vapour, wherein such films further have good optical properties and good balance of optical and mechanical properties, and wherein such films that have a reduced thickness.

This objective has now been achieved according to the present invention by a polymer composition comprising linear low-density polyethylene produced in the presence of a single-site catalyst system, the linear low-density polyethylene having a density as determined according to ISO 1183-1 (2012), method A of ≥900 kg/m³ and ≤940 kg/m³ wherein films produced using the polymer composition have a total defected area of ≤50 ppm of surface, the total defected area being the fraction of surface area of the film accounted for by gels having an equivalent diameter of >50 μm.

Films produced using such polymer compositions have reduced permeability to oxygen and water vapour. Films produced using such polymer compositions have good optical properties such as haze, clarity and gloss. Films produced using such polymer compositions may for example be used in packages for packaging fresh food or dry foodstuffs. Films produced using such polymer compositions may for example be used in flexible packages for packaging fresh food or dry foodstuffs. Films produced using such polymer compositions may have a reduced thickness.

Low permeability properties are also referred to as high barrier properties. In the context of the present invention, permeability is to be understood to be the degree to which a film, for example a single-layer film or a multilayer film, enables molecules of certain defined compounds to pass through said film, for example by means of diffusion. For example, such compound may be oxygen. Alternatively, such compound may be water, for example in the form of water vapour. Certain applications of films may require a certain oxygen permeability. Certain applications of films may require a certain water vapour permeability. Oxygen permeability is expressed as oxygen transmission rate determined in accordance with ISO 15105-2 (2003), method A, and. Water vapour permeability is expressed as water vapour transmission rate determined in accordance with ISO 15106-3 (2003).

In the context of the present invention, linear low-density polyethylenes are to be understood to be polymers obtained by polymerising ethylene as monomer, optionally in the presence of one or more comonomers, in for example a slurry polymerisation process, a gas-phase polymerisation process or a solution polymerisation process, or combinations thereof. The slurry, gas-phase and solution polymerisation processes may be catalytic polymerisation processes. The polymerisation proces may for example include fluidized bed gas-phase reactors, loop reactors, stirred tank reactors, high-pressure reactors, batch reactors in parallel, series, and/or any combinations of at least two thereof.

In the context of the present invention, optical properties may for example include properties such as haze, clarity and gloss. In the context of the present invention, mechanical properties may for example include properties such as the modulus of elasticity, tensile stress, blocking, coefficient of friction, and Elmendorf tear resistance.

As comonomers, for example one or more α-olefins may be used. The one or more α-olefin comonomers may for example be one or more selected from the group of α-olefins having ≥3 and ≤10 carbon atoms. Preferably the one or more α-olefin comonomers comprises an acyclic α-olefin. For example, the one or more α-olefin comonomers may be one or more selected from 1-butene, 1-pentene, 4-methyl-1-pentene, 1-hexene, 1-heptene and/or 1-octene.

The one or more α-olefin comonomers may be present in an amount of for example ≥3.0% by weight, alternatively ≥5.0% by weight, alternatively ≥7.0% by weight, alternatively 10.0 by weight compared to the total weight of the monomers fed to the polymerisation process. The one or more α-olefin comonomers may be present in an amount of for example ≤20.0% by weight, alternatively 5 18.0% by weight, alternatively ≤15.0% by weight, alternatively ≤13.0% by weight compared to the total weight of the monomers fed to the polymerisation process. The one or more α-olefin comonomers may be present in an amount of for example ≥5.0% and ≤20.0% by weight, alternatively ≥7.0% and ≤15.0% by weight compared to the total weight of the monomers fed to the polymerisation process.

In an embodiment, the linear low-density polyethylenes may for example be produced in a solution polymerisation process. A solution polymerisation process for the production of linear low-density polyethylenes in accordance with the present invention is to be understood to be a process in which the polymerisation is performed at for example a temperature in the range of 150-330° C., at for example a pressure in the range of 2.0-15.0 MPa, in which the reaction takes place in a an inert solvent, in which the inert solvent for example has a boiling point below the reaction temperature. For example, said solution polymerisation process is a continuous process.

In an embodiment, the linear low-density polyethylenes may for example be produced in a slurry polymerisation process. A slurry polymerisation process for the production of linear low-density polyethylenes in accordance with the present invention is to be understood to be a process in which the polymerisation is performed at for example a temperature in the range of 70-90° C., at for example a pressure in the range of 0.3-5.0 MPa, in which the reaction takes place in an inert diluent, in which said diluent is for example a hydrocarbon which is inert during the polymerisation process and which is in a liquid phase under the conditions occurring in the polymerisation process. For example, said diluent may be hexane. For example, said slurry polymerisation process is a continuous process.

In an embodiment, the linear low-density polyethylenes may for example be produced in a gas-phase polymerisation process. In an embodiment, the linear low-density polyethylenes may for example be produced in a gas-phase fluidized bed polymerisation process. A gas-phase polymerisation process for the production of linear low-density polyethylenes in accordance with the present invention is to be understood to be a process in which the polymerisation is performed in a reactor in which the polymerisation reaction takes place in a gaseous phase. For example, the linear low-density polyethylene may be produced via a gas-phase polymerisation process in a single gas-phase polymerisation reactor. Alternatively, the polymerization reactor may comprise of two or more reactors in series, parallel, or combinations thereof. Preferably, the polymerization reactor may comprise one reactor, e.g. a fluidized bed gas-phase polymerisation reactor. Such polymerisation reactor may for example comprise a fluidized bed. Such gas-phase polymerisation process may for example be operated by continuously recycling a mixture comprising the reactants, in which feed streams comprising reactants are added in a continuous way, and in which the obtained linear low-density polyethylene is discharged in a continuous way. In an embodiment, the gas-phase polymerization reactor is a continuous polymerisation reactor comprising one or more feed stream inlets. In the polymerisation reactor, the one or more feed streams are combined together to form a gas comprising the reactants, and the gas comprising the reactants ethylene and optionally one or more comonomers is flowed or cycled continuously through the polymerization reactor by any suitable means. The gas comprising ethylene and optionally one or more comonomers may be fed up through a distributor plate to fluidize the bed in a continuous fluidization process.

The reactants may for example be ethylene and optionally comonomers. The mixture comprising the reactants may for example further comprise one or more inert gas or liquid. Such inert gas or liquid may for example be nitrogen, isopentane or hexane or combinations thereof. The mixture comprising the reactants may for example further comprise hydrogen. The mixture comprising the reactants may for example further comprise one or more continuity additive. Such continuity additive may for example be an ethoxylated stearyl amine or aluminium distearate or combinations thereof. The mixture comprising the reactants may for example further comprise a catalyst system. For example, this catalyst system may be a single-site catalyst system. The polymerisation reaction in such gas-phase polymerisation process may for example be operated at a temperature in the range of 70-115° C., at for example a pressure in the range of 1.5-3.0 MPa.

The polymerisation processes for obtaining linear low-density polyethylenes may be catalytic polymerisation processes. Catalytic polymerisation processes are to be understood to be processes in which a catalyst system is added to the polymerisation process. Such catalyst system may for example be a single-site catalyst system.

It is preferable that the ethylene is present in the reactor at a partial pressure at or greater than 160 psia (1100 kPa), or 190 psia (1300 kPa), or 200 psia (1380 kPa), or 210 psia (1450 kPa), or 220 psia (1515 kPa). The comonomer, e.g. one or more alphα-olefins having 3 to 10 carbon atoms, if present in the polymerization reactor, is present at any level that will achieve the desired weight percent incorporation of the comonomer into the polyethylene. This may be expressed as a mole ratio of comonomer to ethylene as described herein, which is the ratio of the gas concentration of comonomer moles in the cycle gas to the gas concentration of ethylene moles in the cycle gas. In one embodiment of the inventive polyethylene composition production, the comonomer is present with ethylene in the mixture comprising the reactants in a mole ratio range of from 0 to 0.1 comonomer to 1 mole of ethylene, for example in a mole ratio range of from 0 to 0.05, for example from 0 to 0.04, for example from 0 to 0.03, for example from 0 to 0.02 comonomer to 1 mole of ethylene.

Hydrogen gas may also be added to the polymerization reactor(s). For example, the ratio of hydrogen to total ethylene monomer (ppm H₂/mol % ethylene) in the circulating gas stream may be in the range from 0 to 60:1, for example from 0.10:1 to 50:1, for example from 0 to 35:1, for example from 0 to 25:1, for example from 7:1 to 22:1.

The optimal amount of the catalyst system to be used in the polymerization can easily be determined by the person skilled in the art through routine experimentation. For example, the amount of the catalyst system may be chosen such that the productivity is in the range from 1500 to 10000 gram polyolefin per gram of the catalyst system.

During the polymerisation small amounts of scavenger, such as aluminium alkyl may also be added to the reactor in order to prevent impurities in the reactor from deactivating or poisoning the catalyst system. Typical scavengers include triisobutyl aluminium, trihexyl aluminium, triisopropyl aluminium, triethylaluminium and trimethyl aluminium (TMA).

During the polymerisation of olefins a continuity aid agent (CAA) may also be added to the reactor. Said continuity aid agent is prepared separately prior to introduction into the reactor by reacting:
at least one metal alkyl or metal alkyl hydride compound of a metal from group IIA or IIIA of the periodic system of elements, and
at least one compound of general formula RₘXR′_{n′}

wherein
R is a branched, straight, or cyclic, substituted or unsubstituted hydrocarbon group having 1 to 50, preferably 10-40, carbon atoms,
R′ is hydrogen or a functional group with at least one active hydrogen, for example an OH group
X is a heteroatom selected from the group of O, N, P or S,
n and m are each at least 1 and are such that the formula has no net charge,
the molar ratio of the metal of the metal alkyl compound and X is about 2:1 to about 10:1.

Preferably the continuity aid agent is the same or different as the modifier present in the composition according to the present invention and is the product of reacting an aluminium compound of general formula (1)

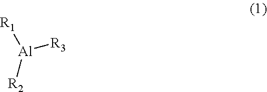

with an amine compound of general formula (2)

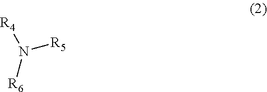

wherein R1, R2, R3, R4, R5 and R6 are as defined herein:
R1 is hydrogen or a branched or straight, substituted or unsubstituted hydrocarbon group having 1-30 carbon atoms,
R2 and R3 are the same or different and selected from branched or straight, substituted or unsubstituted hydrocarbon groups having 1-30 carbon atoms,
R4 is hydrogen or a functional group with at least one active hydrogen
R5 is hydrogen or a branched,straight or cyclic, substituted or unsubstituted hydrocarbon group having 1-30 carbon atoms,
R6 is a branched,straight or cyclic, substituted or unsubstituted hydrocarbon group having 1-30 carbon atoms.

The continuity aid agent is added to the reactor as a further process aid for reducing fouling and or sheeting. The amount is generally in the order of 0.01-0.1 mmol per gram of the single-site catalyst system.

Linear low-density polyethylenes as used in the polymer compositions of the present invention may for example have a density as determined according to ISO 1183-1 (2012), method A of ≥900 kg/m³, alternatively ≥905 kg/m³, alternatively ≥906 kg/m³, alternatively ≥910 kg/m³, alternatively ≥911 kg/m³, alternatively ≥915 kg/m³, alternatively ≥916 kg/m³. Linear low-density polyethylenes as used in the polymer composition of the present invention may for example have a density of ≤940 kg/m³, alternatively ≤935 kg/m³, alternatively ≤934 kg/m³, alternatively ≤930 kg/m³, alternatively ≤929 kg/m³. For example, linear low-density polyethylenes may have a density ≥900 kg/m³ and ≤940 kg/m³, alternatively≥906 kg/m³ and ≤934 kg/m³, alternatively ≥916 kg/m³ and ≤929 kg/m³.

Linear low-density polyethylenes as used in the polymer compositions of the present invention may for example have a melt mass flow rate as determined in accordance with ISO 1133-1 (2011), at a temperature of 190° C. and a load of 2.16 kg, further referred to as MFR(2.16), of ≥0.10 g/10 min, alternatively ≥0.20 g/10 min, alternatively ≥0.40 g/10 min, alternatively ≥0.50 g/10 min, alternatively ≥0.80 g/10 min, alternatively ≥1.00 g/10 min. Linear low-density polyethylenes as used in the polymer compositions of the present invention may for example have an MFR(2.16) of ≤50.0 g/10 min, alternatively ≤40.0 g/10 min, alternatively 30.0 g/10 min, alternatively ≤20.0 g/10 min, alternatively ≤10.0 g/10 min, alternatively ≤5.00 g/10 min. For example, linear low-density polyethylenes as used in the polymer compositions of the present invention may have an MFR(2.16) of ≥0.10 and ≤50.0 g/10 min, alternatively ≥0.20 and ≤20.0 g/10 min, alternatively ≥0.50 and ≤5.00 g/10 min.

The polymer compositions of the present invention may for example comprise a linear low-density polyethylene produced in the presence of a single-site catalyst system. In the context of the present invention, a single-site catalyst system is to be understood as a catalyst system comprising a single-site catalyst component. The single-site catalyst component for example has its active catalytic centres distributed in such way that the reaction that takes place at that particular catalytic centre is not affected by reactions taking place at other catalytic centres.

The single-site catalyst system may for example comprise a single-site catalyst component, a catalyst activator and a modifier. For example, the single-site catalyst system may comprise a support containing a single-site catalyst component, a catalyst activator and a modifier.

The single-site catalyst component may for example be selected from metallocenes or non-metallocenes.

In an embodiment, the polymer composition may for example be produced in the presence of a single-site catalyst system comprising a metallocene single-site catalyst component.

Metallocenes may for example be complexes with one or two groups comprising a cyclopentadienyl moiety which are bonded to a transition metal atom, for example a transition metal selected from the group consisting of lanthanides and metals from group 3,4,5 or 6 of the Periodic System of Elements. Groups comprising a cyclopentadienyl moiety may for example be cyclopentadienyl groups, indenyl groups or fluorenyl groups. In the context of the present invention, a cyclopentadienyl moiety means a part of a compound or complex based on cyclopentadienyl.

The single-site catalyst component may also have one of more stabilizing ligands selected from for example cyclooctatetraenyls, imides, phenoxy imines, amines and the like, each individually substituted or unsubstituted.

The single-site catalyst component may for example be a metallocene according to formula I:

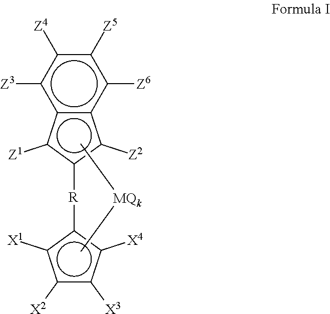

wherein:

M is a transition metal selected from the group consisting of lanthanides and metals from group 3, 4, 5 or 6 of the Periodic System of Elements; M is preferably selected from the group consisting of Ti, Zr and Hf with Zr being most preferred.

Q is an anionic ligand to M,

k represents the number of anionic ligands Q and equals the valence of M minus two divided by the valence of the anionic Q ligand

R is a hydrocarbon bridging group, such as alkyl. R preferably contains at least one sp2-hybridised carbon atom that is bonded to the indenyl group at the 2-position.

Z and X are substituents.

In another embodiment the single-site catalyst component may for example be a metallocene of formula II:

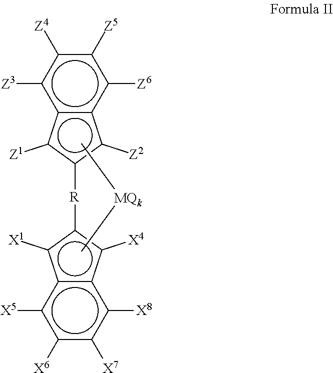

wherein:

M is a transition metal selected from the group consisting of lanthanides and metals from group 3, 4, 5 or 6 of the Periodic System of Elements; M is preferably selected from the group consisting of Ti, Zr and Hf with Zr being most preferred.

Q is an anionic ligand to M,

k represents the number of anionic ligands Q and equals the valence of M minus two divided by the valence of the anionic Q ligand

R is a hydrocarbon bridging group, such as alkyl. R preferably contains at least one sp2-hybridised carbon atom that is bonded to the indenyl group at the 2-position.

Z and X are substituents.

The hydrocarbon bridging group R in the metallocenes of formulas I and II above preferably contains at least one aryl group. For example, the aryl group may be a monoaryl group such as phenylene or naphthalene or a biaryl group, such as biphenylidene or binaphthyl. Preferably the bridging group R stands for an aryl group, preferably R stands for a phenylene or biphenylidene group. The bridging group R is connected to the indenyl groups via a sp2 hybridised carbon atom, for example a phenylene group may be connected via the 1 and the 2 position, a biphenylene group may be connected via the 2 and 2′-position, a naphthalene group may be connected via the 2 and 3-position, a binapthyl group may be connected via the 2 and 2′-position. Preferably R stands for a phenylene group that is connected to the indenyl groups via the 1 and the 2 position. R may be 2,2′-biphenylene.

The substituents X in formulas I and II above may each separately be hydrogen or a hydrocarbon group with 1-20 carbon atoms (e.g. alkyl, aryl, aryl alkyl). Examples of alkyl groups are methyl, ethyl, propyl, butyl, hexyl and decyl. Examples of aryl groups are phenyl, mesityl, tolyl and cumenyl. Examples of aryl alkyl groups are benzyl, pentamethylbenzyl, xylyl, styryl and trityl. Examples of other substituents are halides, such as chloride, bromide, fluoride and iodide, methoxy, ethoxy and phenoxy. Also, two adjacent hydrocarbon radicals may be connected with each other in a ring system. X may also be a substituent which instead of or in addition to carbon and/or hydrogen may comprise one or more heteroatoms from group 14, 15 or 16 of the Periodic System of Elements. Examples of such a heteroatom containing substituents are alkylsulphides (like MeS-, PhS-, n-butyl-S-), amines (like Me2N—, n-butyl-N—), Si or B containing groups (like Me3Si— or Et2B—) or P-containing groups (like Me2P— or Ph2P—).

Preferably the X substituents are hydrogen.

The substituents Z in formulas I and II above may each separately be a substituent as defined above for substituent X. Z1 and Z2 substituents can together with the X1 and X4 substituents form a second bridge.

Examples of metallocenes for use in the present invention are [ortho-bis(4-phenyl-2-indenyl)-benzene]zirconiumdichloride, [ortho-bis(5-phenyl-2-indenyl)-benzene]zirconiumdichloride, [ortho-bis(2-indenyl)benzene]zirconiumdichloride, [ortho-bis(2-indenyl)benzene]hafniumdichloride, [ortho-bis(1-methyl-2-indenyl)-benzene]zirconiumdichloride, [2.2′-(1.2-phenyldiyl)-1.1¹-dimethylsilyl-bis(indene)]zirconiumdichloride, [2,2′-(1,2-phenyldiyl)-1,1′-diphenylsilyl-bis(indene)]zirconiumdichloride, [2,2′-(1.2-phenyldiyl)-1.1′-(1.2-ethanediyl)-bis(indene)]zirconiumdichloride, [2.2′-bis(2-indenyl)biphenyl]zirconiumdichloride and [2,2′-bis(2-indenyl)biphenyl]hafniumdichloride.

The metallocene preferably contains zirconium as metal group M. The zirconium amount in the single-site catalyst system is preferably in the range of 0.02-1.00 wt %, preferably 0.15-0.30 wt % based on the total weight of the single-site catalyst system.

The catalyst activator may be understood as any compound which can activate the single-site catalyst component so that it is capable of polymerisation of monomers, in particular olefins. Olefins may for example be α-olefins such as ethylene, propylene, 1-butene, 1-pentene, 4-methyl-1-pentene, 1-hexene, 1-heptene and/or 1-octene. For example, olefins may be ethylene and/or propylene. Preferably the catalyst activator is an alumoxane, a perfluorophenylborane and/or a perfluorophenylborate, preferably alumoxane, more preferably methylaluminoxane and/or modified methylaluminoxane.

The modifier may for example be a product obtained by reacting an aluminium compound of formula III:

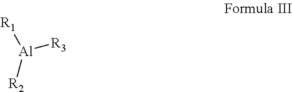

with an amine compound of formula IV:

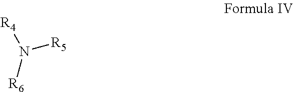

wherein
R1 is hydrogen or a branched or straight, substituted or unsubstituted hydrocarbon group having 1-30 carbon atoms,
R2 and R3 are the same or different and selected from branched or straight, substituted or unsubstituted hydrocarbon groups having 1-30 carbon atoms and
R4 is hydrogen or a functional group with at least one active hydrogen
R5 is hydrogen or a branched, straight or cyclic, substituted or unsubstituted hydrocarbon group having 1-30 carbon atoms,
R6 is a branched, straight or cyclic, substituted or unsubstituted hydrocarbon group having 1-30 carbon atoms.

In the context of the present invention, an active hydrogen is to be understood as a hydrogen atom bound to a heteroatom. Such heteroatom may for example be selected from nitrogen, oxygen, sulfur, phosphorous, boron.

For example, the amounts of aluminium compound and amine compound may be selected such that in the modifier the molar ratio of Al to N is in the range of 1.0:3.0 to 5.0:1.0, preferably 1.0:2.0 to 3.0:1.0, more preferably 1.0:1.5 to 1.5:1.0. The present inventors found that within this range a good combination of technical effects of the present invention can be obtained. If the molar ratio of Al to N is below 1.0:3.0 then fouling and/or sheeting may occur, whereas if the molar ratio of Al to N is above 5.0:1.0 catalyst productivity decreases, i.e. the amount of polymer produced per gram of catalyst decreases. The most preferred molar ratio is 1.0:1.0.

In the compound of formula (IV), R4 is a hydrogen or a functional group with at least one active hydrogen, R5 is hydrogen or a branched, straight or cyclic, substituted or unsubstituted hydrocarbon group having 1-30 carbon atoms, R6 is a branched, straight or cyclic, substituted or unsubstituted hydrocarbon group having 1-30 carbon atoms (carbon atoms of the substituents included). The branched, straight or cyclic, substituted or unsubstituted hydrocarbon group having 1-30 carbon atoms is preferably an alkyl group having 1-30 carbon atoms, for example an alkyl group having 1-30 carbon atoms, for example a straight, branched or cyclic alkyl, an aralkyl group having 1-30 carbon atoms or an alkaryl group having 1-30 carbon atoms.

The amine compound used in the reaction to prepare the modifier may be a single amine compound or a mixture of two or more different amine compounds.

The amine compound used for preparing the modifier of the present invention preferably has a hydrocarbon group of at least eight carbon atoms, more preferably at least twelve carbon atoms, for example an alkyl group of 1 to fifteen carbon atoms. The amine compound may be a primary, secondary or tertiary amine. The amine compound is preferably a primary amine.

In an embodiment of the present invention the amine compound may be selected from the group consisting of octadecylamine, ethylhexylamine, cyclohexylamine, bis(4-aminocyclohexyl)methane, hexamethylenediamine, 1,3-benzenedimethanamine, 1-amino-3-aminomethyl-3,5,5-trimethylcyclohexane and 6-amino-1,3-dimethyluracil. For example the amine compound may be cyclohexylamine.

The aluminium compound used in the reaction to prepare the modifier may be a single aluminium compound or a mixture of two or more different aluminium compounds. R1, R2 and R3 may each independently stand for a branched or straight, substituted or unsubstituted hydrocarbon group having 1-30 carbon atoms, for example may each independently stand for an alkyl, preferably R1, R2 and R3 all stand for an alkyl, more preferably R1, R2 and R3 are the same.

The aluminium compound of the present invention is preferably a trialkylaluminium (R1=R2=R3=alkyl or a dialkylaluminiumhydride (R1=hydrogen, R2=R3 =alkyl).

In an embodiment of the present invention the aluminium compound is selected from the group consisting of of tri-methylaluminium, tri-ethylaluminium, tri-propylaluminium, tri-butylaluminium, tri-isopropylaluminium tri-isobutylaluminium, or di-methylaluminiumhydride, di-ethylaluminiumhydride, di-propylaluminiumhydride, di-butylaluminiumhydride, di-isopropylaluminiumhydride, di-isobutylaluminiumhydride.

An alkyl as used herein will be understood by the skilled person as meaning a hydrocarbon group that contains only carbon and hydrogen atoms and is derived from alkanes such as methane, ethane, propane, butane, pentane, hexane etc. The alkyl may be branched, straight or cyclic. Preferably R1, R2 and R3 may each independently stand for a straight or branched alkyl.

For example, the aluminium compound is a trialkylaluminium and the amine compound is a primary amine, preferably the aluminium compound is selected from the group consisting of octadecylamine, ethylhexylamine, cyclohexylamine, bis(4-aminocyclohexyl)methane, hexamethylenediamine, 1,3-benzenedimethanamine, 1-amino-3-aminomethyl-3,5,5-trimethylcyclohexane and 6-amino-1,3-dimethyluracil.

For example, the modifier is wherein the modifier is the product obtained by reacting octadecylamine, 2-ethylhexylamine or cyclohexylamine with triisobutylaluminium.

The single-site catalyst system as used in the present invention may contain from 0.01-5.00 wt %, preferably from 0.50-3.00 wt %, more preferably from 0.03-2.00 wt % of the modifier, based on the total weight of the single-site catalyst system.

The support in the catalyst system used in the present invention may be an organic or inorganic material and is preferably porous. Examples of organic material are cross-linked or functionalized polystyrene, PVC, cross-linked polyethylene. Examples of inorganic material are silica, alumina, silica-alumina, inorganic chlorides such as MgCl₂, talc and zeolite. Mixtures of two or more of these supports may be used. The preferred particle size of the support is from 1 to 120 micrometres, preferably of from 20 to 80 micrometres and the preferred average particle size is from 40 to 50 micrometres.

The preferred support is silica. The pore volume of the support is preferably of from 0.5 to 3.0 cm³/g. The preferred surface area of the support material is in the range of from 50 to 500 m²/g. The silica used in this invention is preferably dehydrated prior to being used to prepare the catalyst system. In case of a zirconium single-site catalyst component, the amount of zirconium based on the support may for example be in the range from 0.05 to 3.00 wt %.

For example, the single-site catalyst component, the catalyst activator and the modifier are contained by the support. In other words, in the single-site catalyst system of the invention, the single-site catalyst component, the catalyst activator and the modifier are all present on the support, obviating the need for separate addition of the modifier and of the support containing the single-site catalyst component and the activator.

The catalyst system used in the present invention may further comprise a Ziegler-Natta and/or a chromium based catalyst component. Preferably, the catalyst system comprises one catalyst component, more preferably the catalyst component is a metallocene. For example, the catalyst component is 2,2′-bis(2-indenyl)biphenyl zirconium dichloride.

The catalyst system preferably has an aluminium content in the range of 3.0-20.0 wt %, preferably 7.0-12.0 wt % based on the total weight of the catalyst system.

The single-site catalyst system used in the present invention may for example comprise a support containing a metallocene, preferably 2,2′-bis(2-indenyl)biphenyl zirconium dichloride, (methyl)aluminoxane or modified methylaluminoxane and a modifier, wherein the modifier is the product of reacting one or more of octadecylamine, 2-ethylhexylamine or cyclohexylamine with triisobutylamine.

The single-site catalyst system used in the present invention may be prepared by a method comprising the steps of
a) preparing a modifier by reacting an aluminium compound of general formula V:

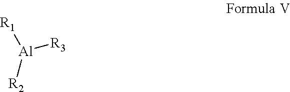

with an amine compound of general formula VI:

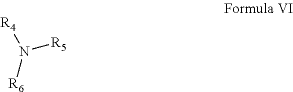

b) activating a single-site catalyst component by adding a catalyst activator to said single-site catalyst component, preferably in an organic solvent such as toluene or xylene to obtain an activated single-site catalyst component
c) combining in a solvent a support material, the activated single-site catalyst component obtained in step b) and the modifier obtained in step a)
d) optionally drying the reaction product obtained in step c)

wherein R1 is hydrogen or a branched or straight, substituted or unsubstituted hydrocarbon group having 1-30 carbon atoms,

R2 and R3 are the same or different and selected from branched or straight, substituted or unsubstituted hydrocarbon groups having 1-30 carbon atoms and

R4 is hydrogen or a functional group with at least one active hydrogen

R5 is hydrogen or a branched,straight or cyclic, substituted or unsubstituted hydrocarbon group having 1-30 carbon atoms,

R6 is a branched, straight or cyclic, substituted or unsubstituted hydrocarbon group having 1-30 carbon atoms.

In a practical embodiment step c) may be carried out by adding the activated single-site catalyst component, optionally including an organic solvent, to the support. The so obtained mixture may further react for at least thirty minutes, preferably at least one hour at a temperature of between 20° C. and 80° C., preferably between 40° C. and 60° C., after which the modifier obtained in step a) is added.

Step a) in the method for preparing the catalyst system is preferably carried out a temperature of 0° C.-50° C., more preferably at a temperature of 10° C. to 35° C.

The single-site catalyst system obtained after drying is a dry flowing powder with particle size range of 1 to 300 microns, more preferably 5 to 90 microns.

The single-site catalyst system is preferably stored under an inert atmosphere, such as nitrogen or argon.

In the context of the present invention, the total defected area is to be understood to be the fraction of the surface area formed by gels having an equivalent diameter of ≥50 μm of a film produced using the polymer composition of the present invention. The total defected area is expressed as parts per million (ppm) of the total surface area of such film.

In an embodiment, films produced using the polymer composition according to the invention may for example have a total defected are of ≤50 ppm of surface area, compared to the total surface area, alternatively ≤40 ppm, alternatively ≤30 ppm, wherein the total defected area is the fraction of the surface area of the film accounted for by gels having an equivalent diameter of ≥50 μm.

Gels are to be understood to be distinct polymeric domains in the polymer material that do not show thermoplastic properties, for example wherein individual polymer molecules are chemically bound to each other as a result of crosslinking, or for example wherein polymer molecules of a high molecular weight form physical bonds which are not reversible by exposing the material to a heat processing step such as is the case in thermoplastic processing.

The gel content may for example be determined via on-line measurement of a film. produced in the cast film system using an FSA-100 film surface analyser obtainable from Optical Control Systems GmbH positioned between the chill roll system and the nip rolls. The film surface analyser may comprise a CCD line scan camera with a resolution of 50 μm, enabling the identification of gels having a dimension of at least 50 μm length and 50 μm width. The film surface analyser may comprise a halogen based illumination system. A continuous image of the film surface may be produced. The determination of gels may be performed using image recognition software provided by Optical Control Systems GmbH integrated with the FSA-100 film surface analyser. A film sample with a total surface size of ≥1.0 m² may be tested, alternatively ≥5.0 m², alternatively ≥1.0 and ≥10.0 m², alternatively ≥5.0 and ≤8.0 m².

The equivalent diameter of a gel is to be understood to be the average of the length and the width of the surface area of each gel as determined via on-line measurement as described above. For example, the equivalent diameter may be the average of the first largest diameter of a gel and the largest second diameter of said gel measured in a direction perpendicular to said first largest diameter of said gel.

The total defected area of a film is determined using the image recognition software provided by Optical Control Systems GmbH integrated with the FSA-100 film surface analyser as described above.

In an embodiment, the polymer composition may for example comprise ≥90.0% by weight of linear low-density polyethylene produced in the presence of a single-site catalyst system, the linear low-density polyethylene having a density as determined to ISO 1183-1 (2012), method A of ≥900 kg/m³ and ≤940 kg/m³, compared to the total weight of the polymer composition.

The polymer composition according to the present invention may for example comprise ≥75.0%, alternatively ≥70.0%, alternatively ≥85.0%, alternatively ≥90.0%, alternatively ≥95.0%, alternatively ≥98.0% by weight of linear low-density polyethylene produced in the presence of a single-site catalyst system, compared to the total weight of the polymer composition.

In an embodiment, said the polymer composition may for example comprise a nucleating agent. For example, the nucleating agent may be an organic nucleating agent, such as a salt of an organic compound.

In an embodiment, the present invention may for example relate to a polymer composition wherein the nucleating agent is selected from the group comprising dicarboxylic acids according to formula VII or salts thereof wherein the cation is selected from calcium, sodium, potassium, lithium or barium

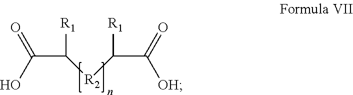

In which:

R₁ is a moiety comprising ≥2 and ≤10 carbon atoms; which moiety may comprise one or more unsaturated bonds, each moiety R₁ may be the same or different; both moieties R₁ may be fused together to form a cyclic structure, such as a cyclic aliphatic structure or a cyclic aromatic structure;

R₂ is a hydrocarbon moiety comprising ≥1 and ≤3 carbon atoms, which moiety may comprise one or more unsaturated bonds;

n is an integer selected from 0 or 1.

The dicarboxylic acid may for example be a cyclic dicarboxylic acid. The dicarboxylic acid may for example be a benzene dicarboxylic acid or a cyclohexane dicarboxylic acid. The dicarboxylic acid may for example be 1,2-cyclohexane dicarboxylic acid, 1,3-cyclohexane dicarboxylic acid, 1,4-cyclohexane dicarboxylic acid, 1,2-benzene dicarboxylic acid, 1,3-benzene dicarboxylic acid or 1,4-benzene dicarboxylic acid.

Such salts of dicarboxylic acids may for example include calcium salts, sodium salts, lithium salts, potassium salts and/or barium salts. Such salts of dicarboxylic acids may for example be 1,2-cyclohexane dicarboxylic acid calcium salt, 1,2-cyclohexane dicarboxylic acid sodium salt, 1,2-cyclohexane dicarboxylic acid potassium salt, 1,3-cyclohexane dicarboxylic acid calcium salt, 1,3-cyclohexane dicarboxylic acid sodium salt, 1,3-cyclohexane dicarboxylic acid potassium salt, 1,4-cyclohexane dicarboxylic acid calcium salt, 1,4-cyclohexane dicarboxylic acid sodium salt, and/or 1,4-cyclohexane dicarboxylic acid potassium salt, 1,2-benzene dicarboxylic acid calcium salt, 1,2-benzene dicarboxylic acid sodium salt, 1,2-benzene dicarboxylic acid potassium salt, 1,3-benzene dicarboxylic acid calcium salt, 1,3-benzene dicarboxylic acid sodium salt, 1,3-benzene dicarboxylic acid potassium salt, 1,4-benzene dicarboxylic acid calcium salt, 1,4-benzene dicarboxylic acid sodium salt, and/or 1,4-benzene dicarboxylic acid potassium salt.

In an embodiment, the nucleating agent is selected from a cyclohexane dicarboxylic acid and/or a cyclohexane dicarboxylic acid salt.

In an embodiment, the present invention may for example relate to a polymer composition according the present invention wherein the nucleating agent is 1,2-cyclohexane dicarboxylic acid calcium salt.

Nucleating agents may for example also be inorganic materials with a small average particle size and a high melting point. Such nucleating agents can remain in solid phase during melt processing of polymers, thus providing sites where polymer spherulites can form.

In an embodiment, the polymer composition according to the present invention may comprise for example ≥0.01% by weight, alternatively ≥0.02% by weight, alternatively ≥0.03, alternatively ≥0.05% by weight, of nucleating agent compared to the total weight of the polymer composition.

In an embodiment, the polymer composition according to the present invention may comprise for example ≤2.00% by weight, alternatively ≤1.00% by weight, alternatively ≤0.50% by weight, alternatively ≤0.20% by weight, alternatively ≤0.10% by weight, of nucleating agent compared to the total weight of the polymer composition.

In an embodiment, the polymer composition according the present invention may comprise ≥0.01% and ≤2.00% by weight of nucleating agent compared to the total weight of the polymer composition.

Alternatively, the polymer composition may comprise for example ≥0.01% and ≤1.00%, alternatively ≥0.02% and ≤0.50%, alternatively ≥0.03% and ≤0.20%, alternatively ≥0.05 and ≤0.10%by weight of nucleating agent compared to the total weight of the polymer composition.

In an embodiment, the invention may for example relate to a film comprising at least one layer comprising a polymer composition according to the present invention.

In an embodiment, the invention may relate to a film having a total defected area of ≤50 ppm of surface, the total defected area being the fraction of surface area of the film accounted for by gels having an equivalent diameter of >50 μm, wherein the film comprises at least one layer comprising a linear low-density polyethylene produced in the presence of a single-site catalyst system, the linear low-density polyethylene having a density as determined according to ISO 1183-1 (2012), method A of ≥900 kg/m³ and ≤940 kg/m³

The films of the present invention may for example comprise one single layer of material comprising at least a polymer composition according to the present invention, or alternatively the films of the present invention may be multi-layer films, comprising multiple layers of materials, at least one of such layers comprising a polymer composition according to the present invention.

For example, said layer may have a thickness of ≥1.0 μm, alternatively ≥5.0 μm, alternatively ≥10.0 μm. For example, said layer may have a thickness of ≤100.0 μm, alternatively ≤50.0 μm, alternatively ≤40.0 μm, alternatively ≤30.0 μm, alternatively ≤25.0 μm. For example, said layer may have a thickness of ≥1.0 and ≤50.0 μm, alternatively ≥5.0 and ≤40.0 μm, alternatively ≥10.0 and ≤25.0 μm.

In an embodiment, the invention may for example relates to a film comprise a layer of material comprising at least a polymer composition according to the present invention wherein may for example a thickness of ≥1.0 μm and ≥100.0 μm.

In an embodiment, the invention may for example relate to a single-layer film.

In an embodiment, the film according to the invention may for example be produced via cast film production or via blow extrusion film production.

The production of films from polymer compositions according to the invention may for example be conducted using blown film production and/or cast film production. Both processes are known in the art and described in e.g. the Handbook of Plastic Films, E. M Abdel-Bary (ed.), Rapra Technology Ltd., 2003, in sections 2.3 and 2.4. The film according to the present invention may be produced via blown film production. Alternatively, the film according to the present invention may be produced via cast film production.

The production via the cast film method involves the extrusion of molten polymers through a flat die head onto a spinning roll to which the extrudate is detained, e.g. by a blast of air. The film is quenched on the surface of the spinning roll, which preferably is cooled, and finally wound onto a roll. Production of films by the blow extrusion method involves the extrusion of the molten polymers through a circular die, in which air is blown to expand and cool the extrudate into a tubular film. Upon cooling, this film is wound onto a roll.

In an embodiment, the invention may for example relate to a package comprising a film according to the invention.

In an embodiment, such package may for example be suitable for packaging of fresh foodstuffs.

In an embodiment, the invention may for example relate to the use of film according to the invention in packaging of fresh foodstuffs.

In an embodiment, the invention may for example relate to a package for fresh foodstuffs wherein the package comprises a film having an oxygen transmission rate determined in accordance with ISO 15105-2 (2003) of ≤6500 cm³/(m²*bar*day) and a water vapour transmission rate determined in accordance with ISO 15105-3 (2003) of ≤15 g/(m²*day), wherein the film comprises at least one layer comprising linear low-density polyethylene produced in the presence of a single-site catalyst system, the linear low-density polyethylene having a density as determined to ISO 1183-1 (2012), method A of ≥900 kg/m³ and ≤940 kg/m³, said layer having a thickness of ≥1.0 μm and ≤1000.0 μm.

In an embodiment, the present invention relates to a package for fresh foodstuffs comprising a film having an oxygen transmission rate of ≤6500 cm³/(m²*bar*day) determined in accordance with ISO 15105-2 (2003) and a water vapour transmission rate determined in accordance with ISO 15105-3 (2003) of ≤15 g/(m²*day), wherein the film for example comprises at least one layer comprising a polymer composition according to the present invention. In an embodiment, said polymer composition for example comprises a nucleating agent. In an embodiment, said nucleating agent may for example be 1,2-cyclohexane dicarboxylic acid or a calcium salt thereof. In an embodiment, said polymer composition may for example comprise 0.01% and ≤2.00% by weight of nucleating agent compared to the total weight of the polymer composition.

The invention will now be illustrated by the following non-limiting examples.

### Experiment I: Preparation of Catalyst

At room temperature, 0.595 kg of 2,2′-bis(2-indenyl)biphenyl zirconium dichloride was added in a first vessel to 36.968 kg of a 30% methylaluminoxane solution (Al content 13.58 wt %) and stirred for 30 min. to form an activated single-site catalyst component. 172 kg of dry toluene was added to 43 kg of Silica 955 form a slurry solution. Silica 955 is a silica obtainable from Grace, having an average surface area of 300 m²/g, an average pore volume of 1.65 g/cm³, and an average pore size of 220 Å. At a temperature of 30° C., the activated single-site catalyst component was added. The temperature was increased to 50° C. under stirring. The modifier was prepared by adding in a second vessel at room temperature 0.114 kg of triisobutylaluminium to a solution of 0.057 kg cyclohexylamine in 9.7 kg of dry toluene. After maintaining the contents of the first vessel at a temperature of 50° C. for 2 hours, the modifier was added to the first vessel. The temperature was lowered to 30° C. The toluene was removed by filtration and the obtained single-site catalyst system was dried by raising the temperature to 55° C. using a flow of warm nitrogen. A solid single-site catalyst system was obtained.

### Experiment II: Polymerisation

Linear low-density polyethylene was produced in a continuous gas phase fluidized bas reactor having an internal diameter of 45 cm and a reaction zone height of 140 cm. The bed of polymer particles in the reaction zone is kept in a fluidized state by a recycle stream that works as a fluidizing medium as well as as a heat dissipating agent for absorbing the exothermal heat generated within the reaction zone.

The reactor was kept at a constant temperature of 87° C. and at a constant pressure of 21.7 bar. Ethylene at a partial pressure of 10.0 bar and hexene were used as raw materials for polymerization. The molar ratio hexene to ethylene was kept at 0.115. These materials form a make-up stream. A continuity aid agent was mixed with the make-up stream as a 2 wt % solution in isopentane as carrier solvent, the continuity aid agent thus being fed at quantities of 0.06-0.12 kg/h.

The solid single-site catalyst system obtained from experiment I was injected directly in the reaction zone of the fluidized bed using purified nitrogen as a carrier gas. The injection rate was adjusted to maintain a constant production rate of 12 kg/hour. The produced polymer was discharged from the reaction zone semi-continuously via a series of valves into a fixed volume chamber. The so obtained linear low-density polyethylene was purged to remove any volatile hydrocarbons and was then treated with humidified nitrogen to deactivate any trace quantities of residual catalyst system. A linear low-density polyethylene was obtained having a density as determined in accordance with ISO 1183-1 (2012), method A, of 918 kg/m³, and a melt mass flow ratio as determined in accordance with ISO 1133-1 (2011), at a temperature of 190° C. and a load of 2.16 kg, of 1.00 g/10 min.

### Experiment III: Production of Linear Low-Density Polyethylene Pellets

The linear low-density polyethylene obtained from experiment II was melt-mixed in a twin screw extruder with subsequent granulation to produce polymer pellets. Pellets were prepared using the ingredient compositions as presented in table I.

TABLE I

| Ingredient | Example A | Example B (C) |
|---|---|---|
| LLDPE | 99.95 | 100.00 |
| Nucleating agent | 0.050 | — |

The quantities in table I indicate the weight % of the individual ingredients compared to the total weight of the ingredients introduced to the twin screw extruder.

As LLDPE, the linear low-density polyethylene obtained from experiment II was used.

As nucleating agent, 1,2-cyclohexanedicarboxylic acid calcium salt (CAS registry nr 491589-22-1) was used, an organic salt having ruler shaped morphology. This nucleating agent allows for production of polyethylene compositions having a high crystallisation temperature and low isothermal crystallisation half time.

Example A relates to polymer compositions according to the present invention. Example B relates to a linear low-density composition for comparative purposes.

### Experiment IV: Production of Films

The polymer pellets obtained from experiment III were processed into single-layer films having a thickness of 25.0 μm by using a ME-20 extruder and a CR-8 cast film system obtainable from Optical Control Systems GmbH. The extruder was operated at a screw speed of 50 rpm, with a temperature profile along the extruder screw of 190° C. in the material feed zone to 215° in the die zone. The extruder was equipped with a die having a fish-tail design, i.e. where the width of the die opening expands in a linear way, to a width of 150 mm. The die had a die gap of 5 mm.

The cast film system comprised a dual chrome plated steel chill roll system having a temperature control system. The chill roll was operated at a temperature of 40° C. The cast film system comprised two rubber nip rolls to pull the film. The speed of the cast film system was controlled by the nip rolls to produce film at a speed of 3.9 m/min.

Gel Content Determination

The gel content was determined via on-line measurement of the film in the cast film system using an FSA-100 film surface analyser obtainable from Optical Control Systems GmbH positioned between the chill roll system and the nip rolls. The film surface analyser comprised a CCD line scan camera with a resolution of 50 μm. The smallest gels that could be identified accordingly had a dimension of 50 μm length and 50 μm width. The film surface analyser comprised halogen based illumination system. A continuous image of the film surface was thus produced. The determination of gels was performed using image recognition software provided by Optical Control Systems GmbH integrated with the FSA-100 film surface analyser. A film sample with a total surface area of 6.0 m² was tested to determine the gel content and the total defected area.

The results of the gel content determination are presented in table II.

TABLE II

| | | | Example A | Example B (C) |
|---|---|---|---|---|
| Equivalent | 50-300 | μm | 145 | 347 |
| diameter | 301-600 | μm | 72 | 193 |
| | 601-1000 | μm | 6 | 29.67 |
| | 1001-1200 | μm | 0.50 | 3.31 |
| | >1200 | μm | 0.83 | 5.8 |

| | | |
|---|---|---|
| Total number of gels having equivalent | 224 | 579 |
| diameter >50 μm | | |
| Total defected area (ppm) | 20 | 70 |

The presented values for the number of gels indicate the number of gels present in the film sample of 6.0 m² having an equivalent diameter in the range as listed in table II.

The total defected area is the fraction of the film surface accounted for by gels having an equivalent diameter of at least 50 μm. The total defected area is expressed as parts per million of surface area (ppm).

Determination of Material Properties

Material properties were determined using pellets obtained from experiment III and films obtained from experiment IV. Properties are presented in table III.

TABLE III

| Property | Method | Unit | Example A | Example B (C) |
|---|---|---|---|---|
| Oxygen | ISO 15105-2 (2003), | cm³/(m²*bar* | 5900 | 11000 |
| transmission rate | method A | 24 h) | | |
| Water vapour | ISO 15106-3 (2003) | g/(m²*24 h) | 12 | 22 |
| transmission rate | | | | |
| Clarity | ASTM D1003 (2000) | % | 99.38 | 98.17 |
| | procedure B | | | |
| Gloss at 60° | ASTM D2457 (2013) | GU | 136 | 94 |
| Haze | ASTM D1003 (2000) | % | 2.5 | 11.1 |
| | procedure B | | | |
| Secant modulus | ASTM D882 (2010) - 1% | MPa | 216 | 151 |
| of elasticity (MD) | strain | | | |
| Secant modulus | ASTM D882 (2010) - 1% | MPa | 315 | 187 |
| of elasticity (TD) | strain | | | |
| Tensile stress at | ASTM D882 (2010) | MPa | 13.67 | 11.72 |
| yield (MD) | | | | |
| Tensile stress at | ASTM D882 (2010) | MPa | 13.40 | 10.26 |
| yield (TD) | | | | |
| Tensile stress at | ASTM D882 (2010) | MPa | 40.55 | 38.00 |
| break (MD) | | | | |
| Tensile stress at | ASTM D882 (2010) | MPa | 33.00 | 36.4 |
| break (TD) | | | | |
| Strain at yield | ASTM D882 (2010) | MPa | 60.80 | 62.00 |
| (MD) | | | | |
| Strain at yield | ASTM D882 (2010) | MPa | 8.30 | 13.20 |
| (TD) | | | | |
| Strain at break | ASTM D882 (2010) | MPa | 404 | 410 |
| (MD) | | | | |
| Strain at break | ASTM D882 (2010) | MPa | 544 | 580 |
| (TD) | | | | |
| Coefficient of | ASTM D1894 (2011) | % | 1.99 | 1.27 |
| friction - static | | | | |
| Coefficient of | ASTM D1894 (2011) | % | 1.58 | 1.16 |
| friction - kinetic | | | | |
| Blocking | ASTM D3354 (2011) | g | 116 | 35 |
| | Procedure B | | | |
| Elmendorf Tear | ASTM D1922 (2009) | g/μm | 16.52 | 16.61 |
| resistance (MD) | | | | |
| Elmendorf Tear | ASTM D1922 (2009) | g/μm | 38.93 | 32.32 |
| resistance (TD) | | | | |

ASTM D1003 (2000) relates to a standard test for determination of haze and luminous transmittance of transparent plastics.
ASTM D2457 (2013) relates to a standard test for determination of specular gloss of plastic films and solid plastics.
ASTM D882 (2010) relates to a standard test for determination of tensile properties of thin plastic sheeting.
ASTM D1894 (2011) relates to a standard test method for determination of static and kinetic coefficients of friction of plastic film and sheeting.
ASTM D3354 (2011) relates to a standard test for determination of blocking load of plastic film by the parallel plate method.
ASTM D1922 (2009) relates to a standard test method for determination of the propagation tear resistance of plastic film and thin sheeting by pendulum method.

The oxygen transmission rate was determined in accordance with ISO 15105-2 (2003), relating to the determination of the gas transmission rate of plastic films and sheeting via equal pressure method, using method A. The value was presented as the quantity of oxygen gas (in cm³) that passes through a film per quantity of film area (in m²) per quantity of gas pressure (in bar) per quantity of time (in units of 24 h). Determination of the oxygen transmission rate was performed at a temperature of 23° C., at a relative humidity of 0%. Test specimens had a sample thickness of 25.0 μm.

The water vapour transmission rate was determined in accordance with ISO 15106-3 (2003), relating to the determination of the water vapour transmission rate of plastic films and sheeting via electrolytic detection sensor method. The value was presented as the quantity of water vapour (in g) that passes through a film per quantity of film area (in m²) per quantity of time (in units of 24 h). Determination of the water vapour transmission rate was performed at a temperature of 38° C., at a relative humidity of 100%. Test specimens had a specimen thickness of 25.0 μm.

The results of the experiments presented here show that polyethylene compositions according to the present invention comprising linear low-density polyethylene produced in the presence of a single-site catalyst system, the linear low-density polyethylene having a density as determined according to ISO 1183-1 (2012), method A of ≥900 kg/m³ and ≤940 kg/m³, wherein films produced using the polymer composition have a total defected area of ≤50 ppm of surface, the total defected area being the fraction of surface area of the film accounted for by gels having an equivalent diameter of >50 μm, may be used to produce films having improved barrier properties as expressed by oxygen transmission rate and water vapour transmission rate, improved blocking properties, improved modulus of elasticity, whilst maintaining good optical properties such as haze, gloss and clarity.

1. Polymer composition comprising ≥0.01% and ≤2.00% by weight of nucleating agent compared to the total weight of the polymer composition and a linear low-density polyethylene produced in the presence of a single-site catalyst system, the linear low-density polyethylene having a density as determined according to ISO 1183-1 (2012), method A of ≥900 kg/m³ and ≤940 kg/m³
wherein films produced using the polymer composition have a total defected area of ≤50 ppm of surface,
the total defected area being the fraction of surface area of the film accounted for by gels having an equivalent diameter of >50 μm as determined with a FSA-100 film surface analyser on a film sample with a total surface size of ≥1.0 m².

2. Polymer composition according to claim 1 wherein the total defected area is determined at a film having a surface area of ≥5.0 m².

3. Polymer composition according to claim 1, wherein the polymer composition comprises a nucleating agent.

4. Polymer composition according to claim 3 wherein the nucleating agent is selected from the group comprising dicarboxylic acids according to formula VII or salts thereof wherein the cation is selected from calcium, sodium, potassium, lithium or barium; 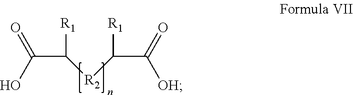
in which:
R₁ is a moiety comprising ≥2 and ≤10 carbon atoms; which moiety may comprise one or more unsaturated bonds, each moiety R₁ may be the same or different; both moieties R₁ may be fused together to form a cyclic structure, such as a cyclic aliphatic structure or a cyclic aromatic structure;
R₂ is a hydrocarbon moiety comprising ≥1 and ≤3 carbon atoms, which moiety may comprise one or more unsaturated bonds;
n is an integer selected from 0 or 1.

5. Polymer composition according to claim 3 wherein the nucleating agent is 1,2-cyclohexane dicarboxylic acid calcium salt.

6. Polymer composition according to claim 1, wherein the single-site catalyst system comprises a metallocene single-site catalyst component.

7. Polymer composition according to claim 1, wherein the polymer composition comprises ≥90.0% by weight of linear low-density polyethylene produced in the presence of a single-site catalyst system, the linear low-density polyethylene having a density as determined to ISO 1183-1 (2012), method A of ≥900 kg/m³ and ≤940 kg/m³, compared to the total weight of the polymer composition.

8. Film having a total defected area of ≤50 ppm of surface, the total defected area being the fraction of surface area of the film accounted for by gels having an equivalent diameter of >50 μm and total defected area being determined with a FSA-100 film surface analyser on a film sample with a total surface size of ≥1.0 m², wherein the film comprises at least one layer comprising a polymer composition comprising ≥0.01% and ≤2.00% by weight of nucleating agent compared to the total weight of the polymer composition and a linear low-density polyethylene produced in the presence of a single-site catalyst system, the linear low-density polyethylene having a density as determined according to ISO 1183-1 (2012), method A of ≥900 kg/m³ and ≤940 kg/m³

9. Film according to claim 8 wherein the layer(s) has/have a thickness of ≥1.0 μm and ≥100.0 μm.

10. Film according to claim 8, wherein the film is a single-layer film.

11. Production of film according to claim 8, via cast film production or via blow extrusion film production.

12. Package comprising a film according to claim 8.

13. (canceled)

14. Package according to claim 12, wherein the package is for fresh foodstuffs and wherein the package comprises a film having an oxygen transmission rate determined in accordance with ISO 15105-2 (2003) of ≤6500 cm³/(m²*bar*day) and a water vapour transmission rate determined in accordance with ISO 15105-3 (2003) of ≥15 g/(m²*day), wherein the film comprises at least one layer comprising linear low-density polyethylene produced in the presence of a single-site catalyst system, the linear low-density polyethylene having a density as determined to ISO 1183-1 (2012), method A of ≥900 kg/m³ and ≤940 kg/m³, said layer having a thickness of ≥1.0 μm and ≤100.0 μm.
